(19) United States
(12) Patent Application Publication
(10) Pub. No.: US 2015/0143375 A1
(43) Pub. Date: May 21, 2015

(54) TRANSACTION EXECUTION IN SYSTEMS WITHOUT TRANSACTION SUPPORT

(71) Applicants: Kelsey L. Bruso, Roseville, MN (US); Ronald G. Smith, Haymarket, VA (US)

(72) Inventors: Kelsey L. Bruso, Roseville, MN (US); Ronald G. Smith, Haymarket, VA (US)

(73) Assignee: UNISYS CORPORATION, Blue Bell, PA (US)

(21) Appl. No.: 14/082,288

(22) Filed: Nov. 18, 2013

(51) Int. Cl. G06F 9/46; G06F 9/455; G06F 9/50

(52) U.S. Cl. CPC G06F 9/466; G06F 9/5061; G06F 9/45533
USPC 718/101

(57) ABSTRACT

Interaction between isolated partitioned execution environments may be permitted through transmission of messages. A method for interaction between partitions may include may include receiving, by a processor, a request message comprising a request to execute a transaction application code; creating, by the processor, an isolated execution environment; starting, by the processor, an operating system in the isolated execution environment; and executing, by the processor, the transaction application code in the operating system.

### FIELD OF THE DISCLOSURE

The instant disclosure relates to computer systems. More specifically, this disclosure relates to processing transactions in computer systems.

### BACKGROUND

Transaction processing is one style of computer processing in use for many decades. In computer systems that support a transaction processing model, a transaction manager may control and direct processing. Examples include a Transaction Interface Package (TIP) transaction manager in conjunction with an Exec operating system, a Transaction Processing Facility (TPF) or the Customer Information Control System (CICS) transaction manager in conjunction with an OS/360, MVS, or zOS operating system, and a Transaction Server transaction manager in conjunction with an MCP operating system.

FIG. 1 is a flow chart illustrating a conventional method of processing transactions. A conventional method 100 accepts a request message 102 and creates an isolated execution environment for the transaction application code related to the request message. The system then executes the transaction application code 106 in the isolated environment and returns the result to the user at block 108.

Some examples of request messages may include “tell me the current balance for my savings account,” “transfer $10.00 from my checking account to my savings account,” “book seat 25A on flight 123 from Minneapolis to Philadelphia departing 2013-02-09 at 7:30 a.m.,” “insert photo d:\mypics\mountain.jpg onto my Facebook page,” and “pay $100.00 to my charge card 4123 from my checking account 123-456.” Upon receiving the request message, the system examines the request and determines which transaction application code should handle the request message.

At block 104, the system creates an isolated execution environment in which to execute the identified transaction application code. This execution environment may be isolated from other processing that is occurring simultaneously on the system. The operating systems mentioned above and their corresponding transaction managers may provide such an isolated execution environment for each transaction application code execution instance. For example, if there are 500 request messages being processed simultaneously by 500 transaction application code instances, each transaction application code execution instance may have its own isolated execution environment. The application code cannot examine, modify, or in any way after another transaction's execution environment. One executing transaction cannot read another executing transaction's memory space or write into another transaction's memory space. One transaction cannot read or alter another transaction's “call—return stack.”

The execution of one transaction at block 106 can affect the execution of another transaction in very controlled and prescribed ways, for example using a shared locking mechanism to serialize database access. One transaction holding a lock on a database item may cause the execution of second transaction to stall until the first transaction releases the lock. Other access to shared middleware services, such as message handling services, print services, and file services, may cause one transaction to stall the execution of another transaction while the service is being rendered.

At block 108, the system returns the result message to the user. The user may be a person using a device such a keyboard, video display, and mouse that is attached directly to the computer system. The user may also be another computer system submitting a request message. In either case, when using the transaction processing model, each transaction execution instance accepts one message and returns one result.

### SUMMARY

Additional methods of allowing one executing application code to interact with another executing application code may allow additional services to be provided by the system and/or increase performance.

According to one embodiment, a method may include receiving, by a processor from a first isolated execution environment, a request message comprising a request to execute a transaction application code. The method may also include creating, by the processor, a second isolated execution environment. The method may further include starting, by the processor, an operating system in the second isolated execution environment. The method may also include executing, by the processor, the transaction application code in the operating system.

According to another embodiment, a computer program product includes a non-transitory computer-readable medium having code to execute the steps of receiving a request message from a first isolated execution environment, in which the request message comprises a request to execute a transaction application code; creating a second isolated execution environment; starting an operating system in the second isolated execution environment; and executing the transaction application code in the operating system.

According to yet another embodiment, a system includes a memory and a processor coupled to the memory. The processor may be configured to perform the steps of receiving, by the processor from a first isolated execution environment, a request message comprising a request to execute a transaction application code; creating, by the processor, a second isolated execution environment; starting, by the processor, an operating system in the second isolated execution environment; and executing, by the processor, the transaction application code in the operating system.

The foregoing has outlined rather broadly the features and technical advantages of the present invention in order that the detailed description of the invention that follows may be better understood. Additional features and advantages of the invention will be described hereinafter that form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features that are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

For a more complete understanding of the disclosed system and methods, reference is now made to the following descriptions taken in conjunction with the accompanying drawings.

FIG. 1 is a flow chart illustrating a conventional method of processing transactions.

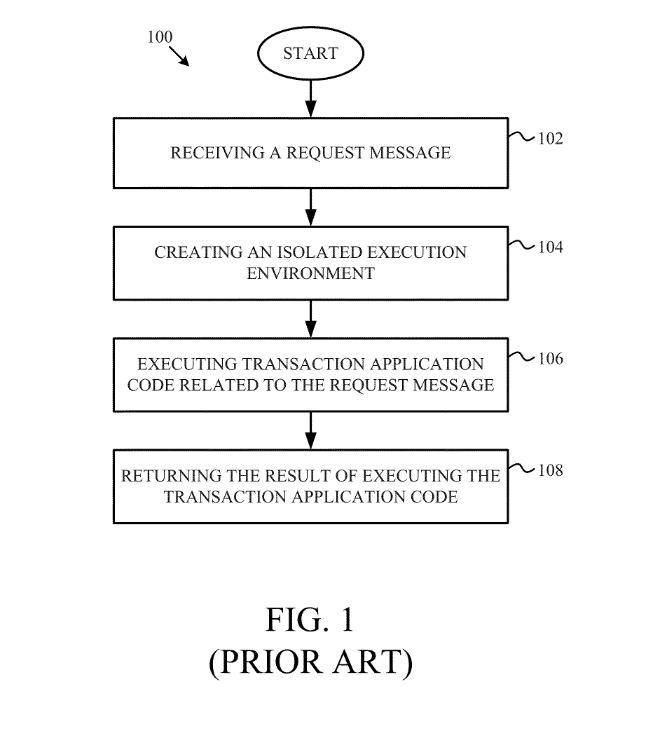

FIG. 2 is a flow chart illustrating message transfer between isolated environments according to one embodiment of the disclosure.

FIG. 3 is a flow chart illustrating a method for processing a transaction in a partitioning hypervisor environment according to one embodiment of the disclosure.

FIG. 4 is a block diagram illustrating a fabric operating system according to one embodiment of the disclosure.

FIG. 5 is a block diagram illustrating a computer network according to one embodiment of the disclosure.

FIG. 6 is a block diagram illustrating a computer system according to one embodiment of the disclosure.

### DETAILED DESCRIPTION

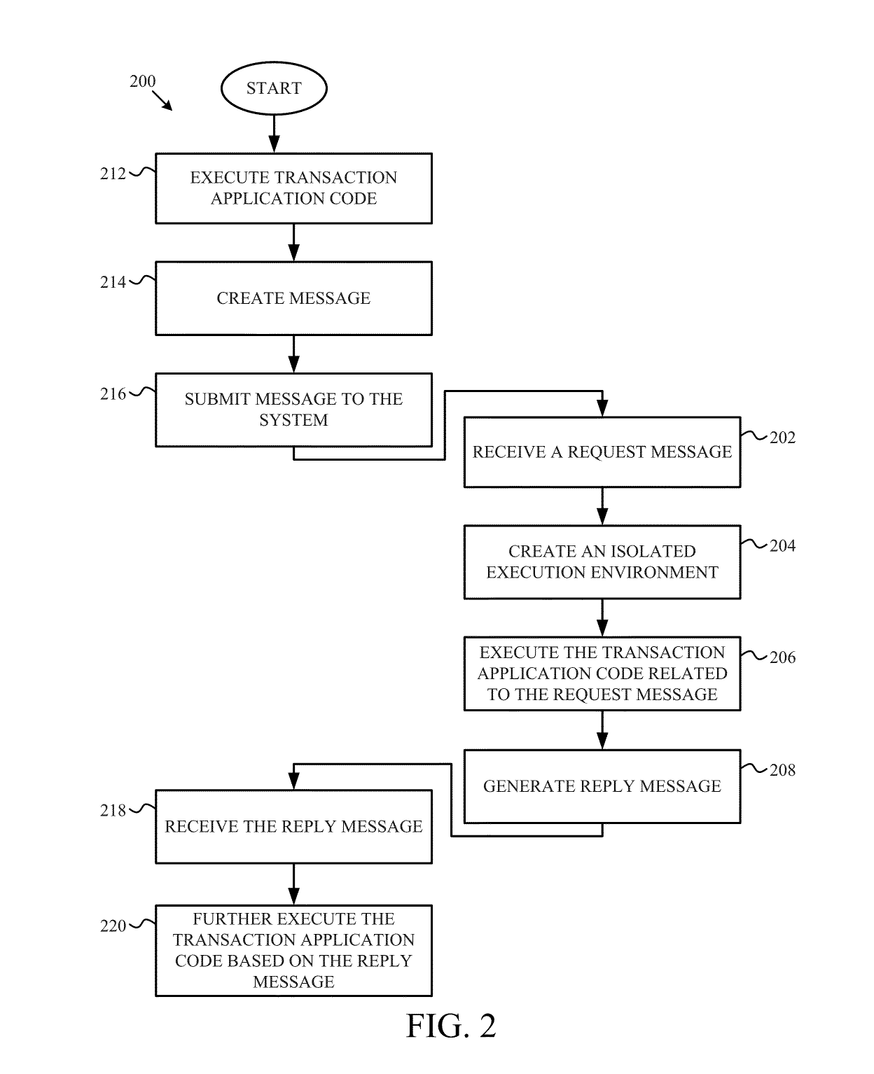

One transaction execution may request a service from another transaction by creating a request message and submitting it to the system as shown in FIG. 2. FIG. 2 is a flow chart illustrating message transfer between isolated environments according to one embodiment of the disclosure. FIG. 2 may be incorporated into, for example, prior art systems by executing the method 200 during processing at block 106. At block 212, the transaction execution code begins processing a request message. As part of the processing, the system may determine that a message should be transmitted to another transaction to process a message on its behalf. At block 214, the transaction execution code creates a message and submits the message to the system for processing at block 216. The message may be received at block 202, an isolated execution environment created at block 204, a related transaction application code executed at block 206 to process the request message, and a reply message generated at block 208.

The reply message may be received in a first isolated execution environment at block 218. Then, the first isolated execution environment may further execute its transaction application code based the reply message at block 220.

The method 200 extends the transaction processing model to systems that previously had none or limited transaction processing capabilities, such as Microsoft® Windows® and Linux®, which do not have the built-in facilities to support the transaction processing model. According to one embodiment, hypervisor technology may be used to create isolated, secure environments in which to execute the transaction application code. In one embodiment, in order to reduce the startup time for each new execution environment created by the hypervisor, the system may implement a set of fabric operating system services to provide common processing capabilities to each execution environment. In one embodiment, the hypervisor may be a partitioning hypervisor that allocates underlying resources to a specific execution environment. The partitioning hypervisor may provide improved likelihood that one execution environment cannot affect another execution environment. The Unisys s-Par® product is an example of one such partitioning hypervisor.

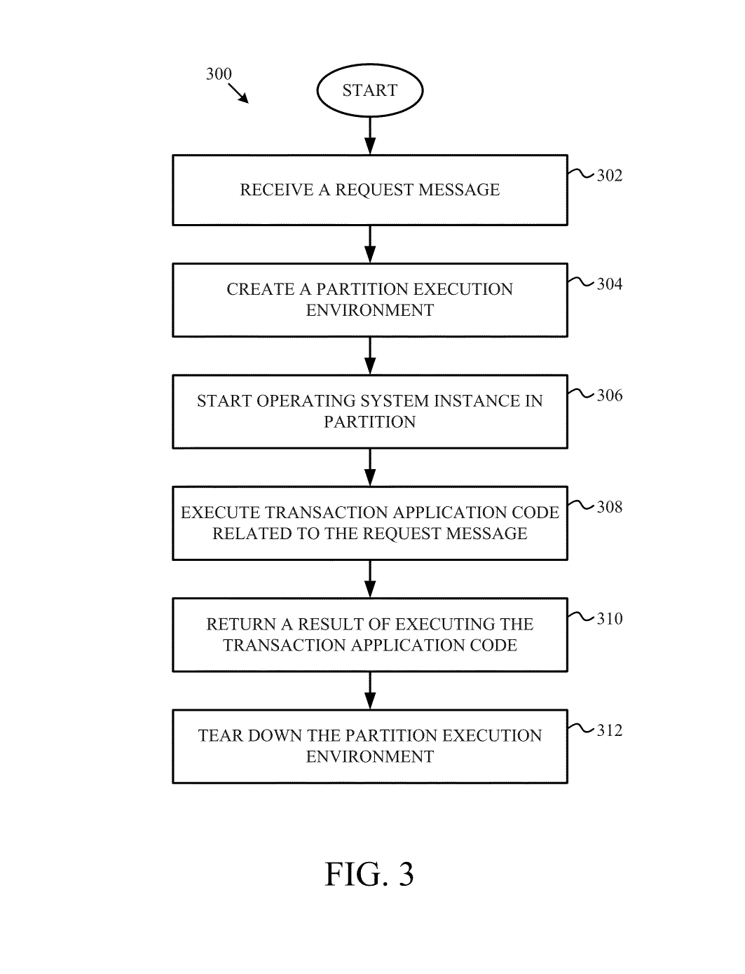

FIG. 3 is a flow chart illustrating a method for processing a transaction in a partitioning hypervisor environment according to one embodiment of the disclosure. The hypervisor may receive a request message at block 302 and create a partition execution environment at block 304, which may be an isolated execution environment in which the transaction application code will execute. Because each partition may exclusively own the underlying hardware resources, the partition may exists in isolation of all other partitions in the environment. In one embodiment, the partitioning hypervisor may manage a single underlying hardware platform, for example, a departmental server. In another embodiment, the partitioning hypervisor may manage a set of underlying hardware platforms.

After creating the partition execution environment at block 304, the partitioning hypervisor may start an operating system instance in the partition at block 306. The operating system may be any operating system supported by the underlying hardware platform and supported by the partitioning hypervisor. For example, the operating system could be a Microsoft® Windows® operating system or a Linux® operating system, even though neither the Windows® operating system nor the Linux® operating system support a native transaction processing model. In one embodiment, the hypervisor may start a standard version of the operating system. In a second embodiment, the hypervisor may start a modified version of the operating system with optional packages omitted. In a third embodiment, the hypervisor may start a modified version of the operating system with common services disabled, with configuration settings pre-established rather than discovered during the boot process, and/or with linkages set by the transaction manager.

After the operating system starts at block 306, the system can process the request message at block 308 and return the results at block 310. At block 312, the hypervisor may stop the operating system and tear down the partition execution environment.

This approach has several advantages including by focusing the operating system execution exclusively on the processing of the request message, the operating system instance may be protected from infection by viruses. Furthermore, the operating system instance may be tailored to support only the execution of the input message, further limiting the attack surface presented to the world.

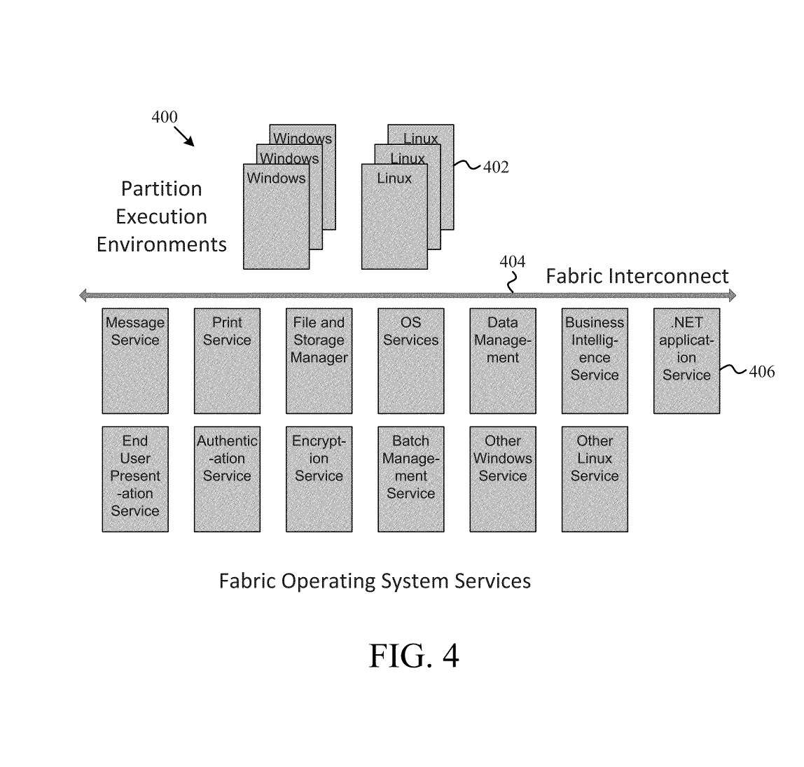

In one embodiment, attributes of the fabric operating system may be used to accelerate the initialization of the operating system environment in order to start processing incoming messages. A fabric operating system may capitalize on the capabilities of the partitioning hypervisor to create and maintain, persistently, the set of services that typically appear within an integrated operating system. FIG. 4 is a block diagram illustrating a fabric operating system according to one embodiment of the disclosure.

A fabric operating system 400 may include partition execution environments 402, in which an operating system instance and transaction code execute. The system 400 may also include fabric operating system services 406, which persist across the creation and destruction of the partition execution environments 402. The system 400 may further include an interconnect fabric 404, which may provide a high speed, low latency connection between the partition execution environments 402 and the fabric operating system services 406, between the partition execution environments 402 themselves, and between the fabric operating system services 406 themselves.

The fabric operating system services shown in FIG. 4 may he representative of the kinds of services that may appear in an integrated operating system. For example, file system services, print services, and data management services execute in standalone partitions, which persist beyond the creation and destruction of every partition execution environment. Additional examples include file and storage managers, OS services, business intelligence services, .NET application services, end user presentation services, authentication services, encryption services, batch management services, other Windows® services, and other Linux® services.

The partitioning hypervisor may create and destroy each partition execution environment 402 in response to the arrival of a request message, such as block 302. Each partition execution environment 402 may have its own dedicated set of hardware resources required for the execution of the transaction application code at block 308, including memory, processor cores, persistent storage access, and/or network access.

To support a transaction processing model in an enterprise, the system 400 may be capable of executing, for example, the method of FIG. 3 thousands of times per second. Thus, the operating system instance created at block 306 of FIG. 3 started in the partition execution environment 402 of FIG. 4 may have services, such as those in the fabric operating system services 406, disabled from its integrated operating system environment. This allows the operating system to start executing with fewer intrinsic services, speeding the startup time. The set of fabric operating system services 406 may be selected to allow sufficient intrinsic services to be disabled in order to achieve the shortened startup time required to support the arrival rate of the request messages at block 302.

In one embodiment, the partitioning hypervisor may create a partition execution environment instance 402 of FIG. 4 and start the operating system instance at block 306 of FIG. 3 in response to the arrival of each request message at block 302. In another embodiment, the partitioning hypervisor may create a pool of partition execution environments 402 that exist in anticipation of the arrival of each request message at block 302. In a third embodiment, the partitioning hypervisor may act as an object factory, instantiating each partition execution environment 402 as if it were an object instance. Once the partitioning hypervisor assigns a request message to a partition execution environment 402, the hypervisor may create a new partition execution environment 402 for the pool. This pool strategy may amortize the cost of creating each partition execution environment 402 of FIG. 4 and starting the operating system instance at block 306 across the set of partition execution environments.

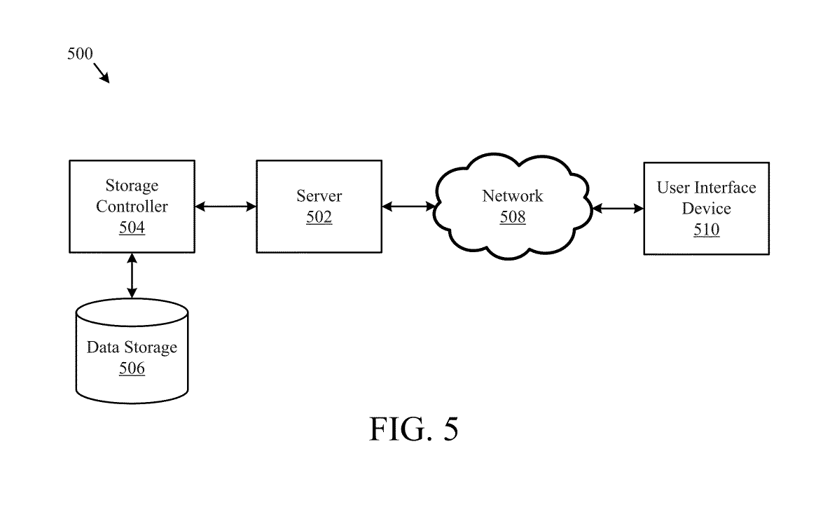

FIG. 5 illustrates one embodiment of a system 500 for an information system, including a system for executing applications and transmitting/receiving data over a network. The system 500 may include a server 502, a data storage device 506, a network 508, and a user interface device 510. In a further embodiment, the system 500 may include a storage controller 504, or storage server configured to manage data communications between the data storage device 506 and the server 502 or other components in communication with the network 508. In an alternative embodiment, the storage controller 504 may be coupled to the network 508.

In one embodiment, the user interface device 510 is referred to broadly and is intended to encompass a suitable processor-based device such as a desktop computer, a laptop computer, a personal digital assistant (PDA) or tablet computer, a smartphone or other a mobile communication device having access to the network 508. In a further embodiment, the user interface device 510 may access the Internet or other wide area or local area network to access a web application or web service hosted by the server 502 and may provide a user interface for enabling a user to enter or receive information, such as reconfigure a hypervisor.

The network 508 may facilitate communications of data between the server 502 and the user interface device 510. The network 508 may include any type of communications network including, but not limited to, a direct PC-to-PC connection, a local area network (LAN), a wide area network (WAN), a modem-to-modem connection, the Internet, a combination of the above, or any other communications network now known or later developed within the networking arts which permits two or more computers to communicate.

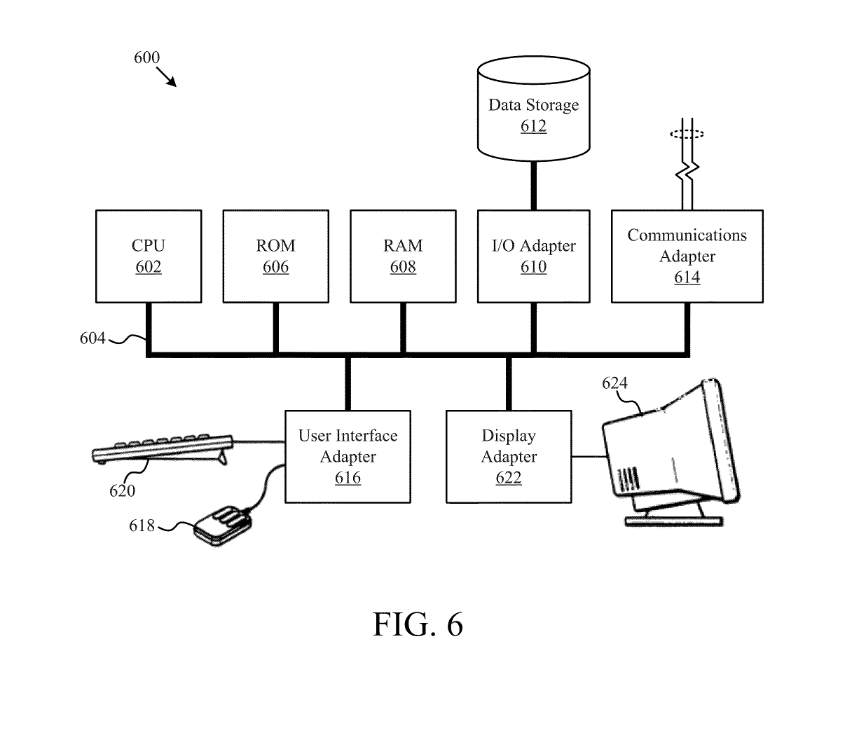

FIG. 6 illustrates a computer system 600 adapted according to certain embodiments of the server 502 and/or the user interface device 510. The central processing unit (“CPU”) 602 is coupled to the system bus 604. The CPU 602 may be a general purpose CPU or microprocessor, graphics processing unit (“GPU”), and/or microcontroller. The present embodiments are not restricted by the architecture of the CPU 602 so long as the CPU 602, whether directly or indirectly, supports the operations as described herein. The CPU 602 may execute the various logical instructions according to the present embodiments.

The computer system 600 also may include random access memory (RAM) 608, which may be synchronous RAM (SRAM), dynamic RAM (DRAM), synchronous dynamic RAM (SDRAM), or the like. The computer system 600 may utilize RAM 608 to store the various data structures used by a software application. The computer system 600 may also include read only memory (ROM) 606 which may be PROM, EPROM, EEPROM, optical storage, or the like. The ROM may store configuration information for booting the computer system 600. The RAM 608 and the ROM 606 hold user and system data, and both the RAM 608 and the ROM 606 may be randomly accessed.

The computer system 600 may also include an input/output (I/O) adapter 610, a communications adapter 614, a user interface adapter 616, and a display adapter 622. The I/O adapter 610 and/or the user interface adapter 616 may, in certain embodiments, enable a user to interact with the computer system 600. In a further embodiment, the display adapter 622 may display a graphical user interface (GUI) associated with a software or web-based application on a display device 624, such as a monitor or touch screen.

The I/O adapter 610 may couple one or more storage devices 612, such as one or more of a hard drive, a solid state storage device, a flash drive, a compact disc (CD) drive, a floppy disk drive, and a tape drive, to the computer system 600. According to one embodiment, the data storage 612 may be a separate server coupled to the computer system 600 through a network connection to the I/O adapter 610. The communications adapter 514 may be adapted to couple the computer system 600 to the network 508, which may be one or more of a LAN, WAN, and/or the Internet. The user interface adapter 616 couples user input devices, such as a keyboard 620, a pointing device 618, and/or a touch screen (not shown) to the computer system 600. The keyboard 620 may be an on-screen keyboard displayed on a touch panel. The display adapter 622 may be driven by the CPU 602 to control the display on the display device 624. Any of the devices 602-622 may be physical and/or logical.

The applications of the present disclosure are not limited to the architecture of computer system 600. Rather the computer system 600 is provided as an example of one type of computing device that may be adapted to perform the functions of the server 502 and/or the user interface device 510. For example, any suitable processor-based device may be utilized including, without limitation, personal data assistants (PDAs), tablet computers, smartphones, computer game consoles, and multi-processor servers. Moreover, the systems and methods of the present disclosure may be implemented on application specific integrated circuits (ASIC), very large scale integrated (VLSI) circuits, or other circuitry. In fact, persons of ordinary skill in the art may utilize any number of suitable structures capable of executing logical operations according to the described embodiments. For example, the computer system 600 may be virtualized for access by multiple users and/or applications.

If implemented in firmware and/or software, the functions described above may be stored as one or more instructions or code on a computer-readable medium. Examples include non-transitory computer-readable media encoded with a data structure and computer-readable media encoded with a computer program. Computer-readable media includes physical computer storage media. A storage medium may be any available medium that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to store desired program code in the form of instructions or data structures and that can be accessed by a computer. Disk and disc includes compact discs (CD), laser discs, optical discs, digital versatile discs (DVD), floppy disks and blu-ray discs. Generally, disks reproduce data magnetically, and discs reproduce data optically. Combinations of the above should also be included within the scope of computer-readable media.

In addition to storage on computer readable medium, instructions and/or data may be provided as signals on transmission media included in a communication apparatus. For example, a communication apparatus may include a transceiver having signals indicative of instructions and data. The instructions and data are configured to cause one or more processors to implement the functions outlined in the claims.

Although the present disclosure and its advantages have been described in detail, it should be understood that various changes, substitutions and alterations can be made herein without departing from the spirit and scope of the disclosure as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the present invention, disclosure, machines, manufacture, compositions of matter, means, methods, or steps, presently existing or later to be developed that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

What is claimed is:

1. A method, comprising:
receiving, by a processor from a first isolated execution environment, a request message comprising a request to execute a transaction application code;
creating, by the processor, a second isolated execution environment;
starting, by the processor, an operating system in the second isolated execution environment; and
executing, by the processor, the transaction application code in the operating system.

2. The method of claim 1, in which the step of creating the isolated execution environment comprises executing a partitioning hypervisor to create a partition execution environment.

3. The method of claim 2, in which the step of creating the partition execution environment comprises allocating resources to the partition execution environment.

4. The method of claim 1, in which the step of starting the operating system comprises starting a modified version of the operating system with common services disabled.

5. The method of claim 1, further comprising:
receiving, by a processor, a second request message comprising a request to execute a second transaction application code;
creating, by the processor, a third isolated execution environment; and
executing, by the processor, the second transaction application code in the third isolated execution environment.

6. The method of claim 1, further comprising executing at least one fabric operating system service available to the second isolated execution environment and the third isolated execution environment.

7. A computer program product, comprising:
a non-transitory computer-readable medium comprising code to execute the steps of:
receiving a request message from a first isolated execution environment, the request message comprising a request to execute a transaction application code;
creating a second isolated execution environment;
starting an operating system in the second isolated execution environment; and
executing the transaction application code in the operating system.

8. The computer program product of claim 7, in which the step of creating the isolated execution environment comprises executing a partitioning hypervisor to create a partition execution environment.

9. The computer program product of claim 8, in which the step of creating the partition execution environment comprises allocating resources to the partition execution environment.

10. The computer program product of claim 7, in which the step of starting the operating system comprises starting a modified version of the operating system with common services disabled.

11. The computer program product of claim 7, in which the medium further comprises code to perform the steps of:
receiving a second request message comprising a request to execute a second transaction application code;
creating a third isolated execution environment; and
executing the second transaction application code in the third isolated execution environment.

12. The computer program product of claim 11, in which the medium further comprises code to perform the step of executing at least one fabric operating system service available to the second isolated execution environment and the third isolated execution environment.

13. An apparatus, comprising:
a memory;
a processor coupled to the memory, in which the processor is configured to execute the steps of:
receiving, by the processor from a first isolated execution environment, a request message comprising a request to execute a transaction application code;
creating, by the processor, a second isolated execution environment;
starting, by the processor, an operating system in the second isolated execution environment; and
executing, by the processor, the transaction application code in the operating system.

14. The apparatus of claim 13, in which the step of creating the isolated execution environment comprises executing a partitioning hypervisor to create a partition execution environment.

15. The apparatus of claim 14, in which the step of creating the partition execution environment comprises allocating resources to the partition execution environment.

16. The apparatus of claim 13, in which the step of starting the operating system comprises starting a modified version of the operating system with common services disabled.

17. The apparatus of claim 13, in which the processor is further configured to perform the steps of:
receiving, by a processor, a second request message comprising a request to execute a second transaction application code;
creating, by the processor, a third isolated execution environment; and
executing, by the processor, the second transaction application code in the third isolated execution environment.

18. The apparatus of claim 17, in which the processor is further configured to perform the step of executing at least one fabric operating system service available to the second isolated execution environment and the third isolated execution environment.
